(19) United States
(12) Patent Application Publication
(10) Pub. No.: US 2012/0020348 A1
(43) Pub. Date: Jan. 26, 2012

(54) COEXISTENCE INTERFACE AND ARBITRATION FOR MULTIPLE RADIOS SHARING AN ANTENNA

(75) Inventors: Anssi K. Haverinen, San Diego, CA (US); Joel B. Linsky, San Diego, CA (US)

(73) Assignee: QUALCOMM Incorporated, San Diego, CA (US)

(21) Appl. No.: 12/840,571

(22) Filed: Jul. 21, 2010

(51) Int. Cl. H04H 20/67; H04B 1/38

(52) U.S. Cl. 370/339; 375/219

(57) ABSTRACT

A serial coexistence interface between two radio devices is involved in arbitrating access to an antenna. The serial interface involves messages that are sent from one radio to the other radio. Serial messages communicated across the same conductor can communicate: 1) timing-precise antenna arbitration and control information, and 2) communication system state information. Examples of antenna arbitration timing-precise information include a request to use the antenna and a corresponding grant or no grant response. Communication system state information, on the other hand, is not involved in the carrying out of the mechanics of the packet-by-packet arbitration for the antenna, but rather is higher level system information usable to make higher level decisions about the arbitration strategy used. Communication system state information may include an indication of a button press, an indication of a user action, or a change in the operational mode of the higher level communication system.

### BACKGROUND INFORMATION

1. Technical Field

The disclosed embodiments relate to a collaborative coexistence interface for facilitating the sharing of a single antenna by multiple radio devices.

2. Background Information

Bluetooth and WLAN (Wireless LAN) are two competing radio technologies that operate on the same 2.4 GHz unlicensed band. WLAN is standardized in IEEE 802.11 and has several variants including the most recent IEEE 802.11(n). Bluetooth is a commercial implementation of a Wireless Personal Area Network (WPAN) technology standardized in IEEE 802.15.1. If a Bluetooth radio and a WLAN radio are located together such that their respective two antennas are very close to one another, then the two radios may interfere with each other and degrade each other's performance. In cellular telephone and laptop computers and other small form factor products, there is often a need to support both Bluetooth and WLAN connectivity at the same time. The two radios need to “coexist” in the small form factor product. Due to the small form factor, either two antennas are provided that are very close to one another or there is one antenna provided that is used by both radios. In a cellular telephone, the cellular telephone antenna is yet another antenna disposed in the small form factor.

FIG. 1 (Prior Art) is a simplified block diagram of a cellular telephone 1 that has a Bluetooth radio device 2 and a WLAN radio device 3 (WLAN). In this particular example, the same antenna 4 is used by both radio devices because sharing the same antenna is less expensive and the package can be smaller than if two antennas were provided. The two radios, however, cannot both be transmitting at the same time. Sometimes both radios can receive at the same time, but only one can transmit at a time. Time-sharing the antenna is therefore necessary. The two radios therefore need to share information in order to determine which one will have access to the antenna. There is a two-position switch 5 coupling one of the two radios to the antenna 4 and that switch is either in one position or the other. In one example, WLAN 3 controls the switch and controls whether it is in the Bluetooth position or the WLAN position. The Bluetooth and WLAN radio devices are time division multiplexed in the sense that they send and receive packets of information. Neither one is transmitting or receiving continuously. Communication of a packet requires from hundreds of microseconds to a number of milliseconds. In order to communicate successfully, an entire packet must generally be sent and a response must be received in return. In the illustrated example, an arbiter is located in the WLAN radio device and this arbiter may give access to the antenna to the Bluetooth device, or the arbiter may not grant access so that the WLAN will maintain access to the antenna. Once the arbiter gives access to the Bluetooth radio device, the Bluetooth device needs to complete a piece of communication such as by sending a message and receiving a response. After the Bluetooth device has completed communicating its piece of communication, the WLAN radio device may take back control of the antenna so that the WLAN device can then complete communicating a piece of its own communication (for example, the sending a message and the receiving of a response). Communication proceeds in this way with the two radios taking turns using the antenna.

In order to carry out this time division multiplexing scheme, the Bluetooth radio device needs to communicate to the WLAN radio device timing-precise information indicating, among other things, exactly when the Bluetooth device is transmitting with microsecond accuracy and when it is stopping. A digital signal line 6 called BT ACTIVE is provided. If the digital signal on this line is high, then the Bluetooth device is indicating that it wants access to the antenna. The arbiter in the WLAN device responds with a digital signal TX CONFIRM on a signal line 7. TX CONFIRM indicates whether the arbiter in the WLAN device has given the Bluetooth device a grant of access to the antenna or has refused to give a grant.

In addition, various wireless communications of the Bluetooth and the WLAN devices may be of different priorities. For example, the communication of audio is of a high priority and should be an uninterrupted audio stream as compared to communications involving searching for other Bluetooth devices. The Bluetooth device does periodic searches for other Bluetooth devices, but determining whether such connectivity can be established is not considered to be as important as is maintaining an uninterrupted telephone call. The PTA interface involves a line 8 from the Bluetooth radio device that carries the digital signal BT PRIORITY (STATUS). The information on this line is serially encoded to indicate whether Bluetooth wants to transmit or to receive, and also whether the communication is of a higher or a lower priority. When BT_ACTIVE is asserted, BT PRIORITY will immediately toggle low or high in a first amount of time to indicate whether the communication being requested is an RX or a TX, and will then toggle high or low in a second amount of time to indicate whether it wishes to engage in a high priority or a low priority communication. The combination of these three lines 6-8 and the associated protocol is referred to as the “PTA interface.” There are different flavors of the PTA interface, such as a two-wire interface version and a four-wire interface version, but the PTA interface is almost universally used when Bluetooth and WLAN devices are to share the same antenna in a small form factor device. The basic principal is that Bluetooth device sends the WLAN device just enough information so the arbiter in the WLAN device can make decisions from one Bluetooth packet to the next as to whether to allow the Bluetooth device access to the antenna or not. If the Bluetooth device is not using the antenna, then WLAN can use the antenna itself.

In addition to the need to communicate low-level timing-precise information between the Bluetooth and WLAN devices, there also exists a need to communication other higher level information between the Bluetooth and WLAN functionalities. An example of a need to communicate such higher level information involves the WLAN arbiter arbitrating antenna access differently in different situations. For example, the Bluetooth protocol includes several high level modes including the so-called “hands free” profile and the so-called “headset profile”. In the hands free profile, there is generally bidirectional conversational voice information at regular intervals. In the “headset” profile, in contrast, there is unidirectional audio information that passes to the headset and the unidirectional transfers occur in a less regular and more bursty manner. The arbiter in the WLAN device cannot project from the current transmission when the Bluetooth device will request access to make the next transmission. The arbiter should arbitrate access to the antenna differently in the two profile situations, but the arbiter cannot determine just from information received via the PTA interface whether the Bluetooth device is requesting use of the antenna for use in a high priority profile, or for use in a low priority profile.

A second high-level communication path is therefore provided as illustrated in FIG. 1 so that additional information can be communicated between the Bluetooth and WLAN functionalities. The additional information can be brought to bear in the WLAN device's decisions on whether or not to grant antenna access. Cellular telephone 1 has a main processor 9 that runs the operating system 10 of the cellular telephone, application programs that execute on the operating system, a Bluetooth stack 12 and a WLAN stack 14. A Bluetooth driver 11 provides an interface to the Bluetooth device 2. A WLAN driver 13 provides an interface to the WLAN device 3. The second high-level communication path involves the passing of software messages between the two protocol stacks as indicated by arrow 15. For example, system state information can pass from the Bluetooth device 2 to the WLAN device 3 indicating that Bluetooth is starting voice call, that Bluetooth is ending voice call, that Bluetooth is starting stereo/audio, that Bluetooth is ending stereo/audio, that Bluetooth is starting scanning for other headsets, and that Bluetooth is stopping searching for other headsets. The WLAN device 3 receives the system state information from its WLAN driver 13 and uses this information to change the coexistence control algorithm it is using to control antenna arbitration. It can select a different strategy for situations involving the communication of voice traffic over Bluetooth, situations involving a data file transfer over Bluetooth, situations involving the use of the Bluetooth link of stereo/audio streaming, and situations in which the Bluetooth device is searching for other Bluetooth devices. The WLAN arbiter can treat all of these cases differently. For example, the arbiter can allow the Bluetooth device a different amount of communication time before the WLAN device takes back control of the antenna. For example, the arbiter can block and interrupt a different aggregate amount of Bluetooth communication in each case. Whereas the timing-precise signaling across the PTA interface is happening in the microsecond time domain, the high-level driver-to-driver software messaging is occurring in the second time domain on a less urgent basis.

FIG. 2 (Prior Art) is a diagram of an operational example involving the cellular telephone of FIG. 1. Cellular telephone 1 has a web browser functionality. Access to the internet 17 is provided from cellular telephone 1, via the WLAN device 3 and a WLAN link 18, to a WLAN access point 19, and then through a connection such as the wired connection 20 to the internet 17. In the example being set forth here, the user is not initially surfing the internet. The user is wearing a wireless headset 21 that is linked to cellular telephone 1 via Bluetooth device 2 and Bluetooth link 22. The headset 21 is also not initially being used to receive audio information from the cellular telephone but the link to it is being maintained. An idle Bluetooth connection 23 is being maintained between cellular telephone 1 and a laptop computer 24. Although link 23 is idle, periodic high priority connection maintenance messages are communicated between cellular telephone 1 and laptop 24 in order to maintain the Bluetooth connection. If such messages are not received, then connection 23 between the cellular telephone 1 and laptop 24 can be lost. The arbiter of the WLAN device 3 is arbitrating access to the antenna 4 via the PTA interface, on a packet by packet basis, to maintain the links 18, 22 and 23.

In this example, there is an incoming telephone call to be received by cellular telephone 1. The telephone rings and the user picks up the telephone call by pressing a button on headset 21. The pressing of the button is a Bluetooth event called “start phone call” that signals a change of system state. This event is communicated in a communication path from headset 21, via link 22, through Bluetooth device 2, to the Bluetooth driver 11, to the WLAN driver 13, and to the arbiter in WLAN device 3. Upon receiving the information, the arbiter changes its strategy for PTA arbitration and gives more antenna access to the Bluetooth device. The operating system of the telephone routes telephone call audio information to the Bluetooth driver so that the information can pass through Bluetooth device 2 and across Bluetooth link 22 and to the headset 21. Similarly, the user's speech in the telephone conversation passes in the opposite direction.

Next, the user starts to use the web browser functionality of cellular telephone to do web browsing. At times, this web browsing is undesirably slow due to limited access to antenna 4 or radio interference. More access should be given to the WLAN device in order to increase web browsing speed and to reduce bandwidth between the headset and the cellular telephone. Some degradation of audio quality in the telephone call is desirable in this circumstance because the degradation is periodic. Moreover, when the audio quality is degraded it need not be seriously degraded. The arbiter in the WLAN device, however, only receives requests across the PTA interface from the Bluetooth device to use the antenna with high priority. The arbiter in the WLAN device cannot know whether such a request is a request made for a communication involving the headset or is for a communication involving the laptop. If a communication to the laptop were to be delayed, then the connection to the laptop may be lost. The arbiter cannot therefore reduce access to the headset because an attempt to do so might reduce access to the laptop and sever the link to the laptop. The WLAN device therefore yields to all high priority Bluetooth requests signaled across the PTA interface.

In addition to the problem described above of the PTA interface not communicating adequate information in certain situations, there are additional problems with the driver-to-driver communication in the conventional system of FIG. 1. The driver-to-driver software communication within the cellular telephone should be implemented in a reliable fashion. Achieving this reliability may be difficult because the devices 2 and 3 may be made by companies different from the companies that make the drivers. Yet another company may make the cellular telephone and the cellular telephone operating system. The drivers may need to be operable across multiple different operating systems. The driver-to-driver software communication 15 needs to be implemented, tested and verified for each different possible operating condition. For a company making a Bluetooth/WLAN device and its associated driver, an undesirable amount of effort and expense may be involved in having to implement the driver and the driver-to-drive communication reliably across all different permutations of operating systems and drivers made by various different entities.

### SUMMARY

A collaborative serial coexistence interface is provided between first and second radio devices. Serial messages are communicated from the first radio device to the second radio device across one interface conductor, and serial messages are communicated from the second radio device to the first radio device across a second interface conductor.

In a first novel aspect, serial messages communicated across the same conductor of the same serial coexistence interface can communicate: 1) timing-precise antenna arbitration and control information, and 2) communication system state information. Examples of timing-precise antenna arbitration and control information may include a request to use the antenna to transmit, a request to use the antenna for receiving, a corresponding grant or no grant response, and a communication that indicates that the device that sent the communication has stopped using the antenna. Such timing-precise antenna arbitration and control information is typically generated by hardware on one radio device and is sent to hardware on the other radio device in the carrying out of packet-by-packet arbitration of access to the antenna. In one example, timing-precise antenna arbitration and control information is signaling information that would otherwise in the prior art have been communicated by hardware signaling across a conventional PTA interface.

Examples of communication system state information, on the other hand, may include: an indication of a button press, an indication of a user action, an indication of a starting or stopping of a synchronous Bluetooth connection, an indication of a starting or stopping of an asynchronous Bluetooth connection, an indication of a starting or stopping of an audio stream, an indication of a starting or stopping of a telephone call, an indication of a starting or stopping of streaming video playback, an indication of a starting or stopping of a paging operation, and an indication of a starting or stopping of a scanning operation. Communication system state information, in contrast to the timing-precise antenna arbitration and control information, is not involved in the carrying out of the timing-precise mechanics of the packet-by-packet arbitration for the antenna, but rather is higher level state information usable to make higher level decisions about what arbitration strategy to use. In one example, the communication system state information is state information that would otherwise in the prior art have been communicated between drivers using direct driver-to-driver software messaging. In one example, communication system state information is communicated across the serial interface between the radio devices and no communication system state information is communicated between drivers using software messaging. As a result, problems in the prior art associated with driver-to-driver software messaging are avoided.

In a second novel aspect, a single multi-bit serial message sent across a serial coexistence interface includes: 1) information indicating which one of more than two levels of priority applies to a communication being requested by a device sending the message, 2) information indicating whether the device sending the message is requesting access to an antenna for transmitting (TX) or for receiving (RX), and 3) information indicating whether the device sending the message is active or not. In one example, individual request messages sent from a Bluetooth device to an arbiter in a WLAN device have three bits to indicate one of eight different priority levels. Where the Bluetooth device is requesting access to the antenna and is servicing two high priority Bluetooth links, and where one link is of higher priority than the other, the arbiter can use the multi-bit priority indicated in an incoming request to selectively reduce access given to the link of lower priority without inadvertently reducing access to the highest priority link.

The foregoing is a summary and thus contains, by necessity, simplifications, generalizations and omissions of detail; consequently, those skilled in the art will appreciate that the summary is illustrative only and does not purport to be limiting in any way. Other aspects, inventive features, and advantages of the devices and/or processes described herein, as defined solely by the claims, will become apparent in the non-limiting detailed description set forth herein.

### BRIEF DESCRIPTION OF THE DRAWINGS

FIG. 1 (Prior Art) is a diagram of a cellular telephone that employs a conventional PTA interface.

FIG. 2 (Prior Art) is a diagram of an operational example involving the cellular telephone of FIG. 1.

FIG. 3 is a diagram of a cellular telephone that includes a serial coexistence interface in accordance with two novel aspects.

FIG. 4 is a diagram of the receive portion of the UART in the arbitration functionality 104 of the WLAN device 102 of FIG. 3.

FIG. 5 is a diagram of the transmit portion of the UART in the arbitration functionality 104 of the WLAN device 102 of FIG. 3.

FIG. 6 is a waveform diagram that illustrates several items of information (events) whose communication requires precise timing.

FIG. 7 is a diagram of the structure of a message communicated across the serial coexistence interface of FIG. 3, where the message is used to communicate timing-precise information.

FIG. 8 is a diagram of the structure of a message communicated across the serial coexistence interface of FIG. 3, where the message is used to communicate communication system state information.

FIG. 9 is a diagram that sets forth opcodes used in the message structure of FIG. 8 to denote various different types of communication system state information, where the opcodes are for software events (idle).

FIG. 10 is a diagram that sets forth opcodes used in the message structure of FIG. 8 to denote various different types of communication system state information, where the opcodes are for software events that are connection oriented.

FIG. 11 is a flowchart of a method 500 in accordance with a first novel aspect.

FIG. 12 is a flowchart of a method 600 in accordance with a second novel aspect.

### DETAILED DESCRIPTION

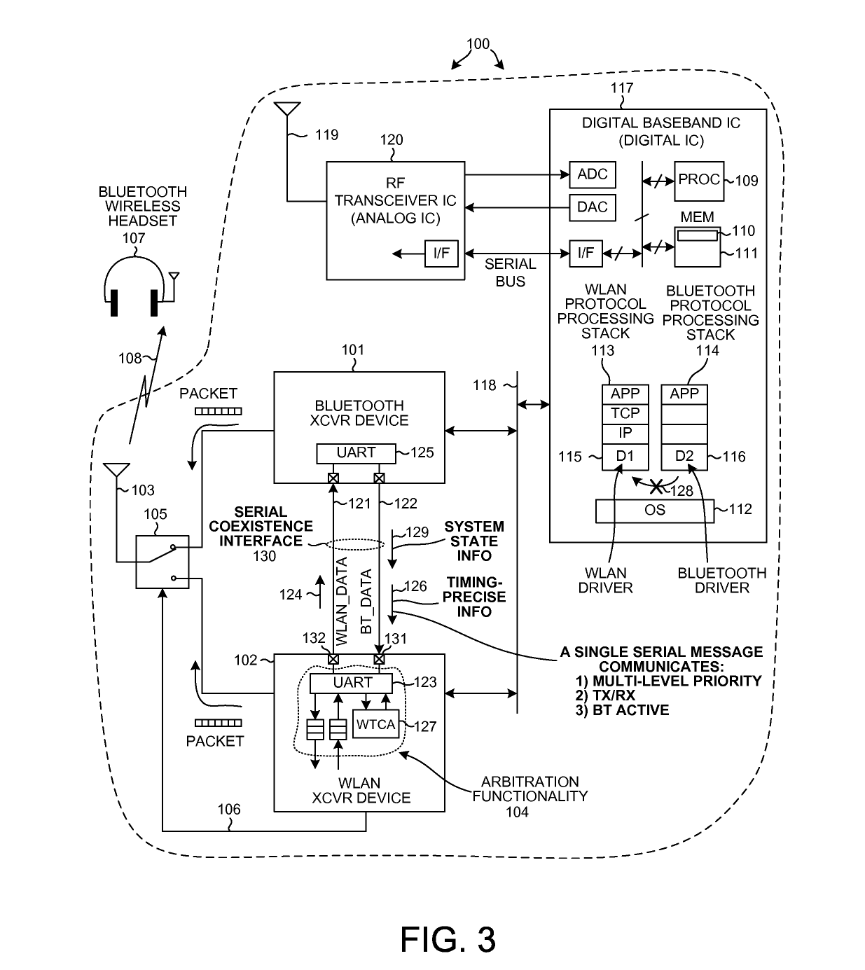

FIG. 3 is a very simplified high level block diagram of a cellular telephone 100 in accordance with two novel aspects. Two radio devices 101 and 102 want to coexist and to share the same antenna 103. Radio device 101 is a Bluetooth transceiver and functionality and may be realized as one or more integrated circuits. Radio device 102 is a WLAN transceiver and functionality and may be realized as one or more integrated circuits. WLAN device 102 includes an arbitration functionality 104 and controls a two-position switch 105 via a signal on conductor 106. A user of the cellular telephone can listen to music, and can hear the audio of a cellular telephone call, via Bluetooth wireless headset 107 and a Bluetooth wireless link 108 to antenna 103. Processor 109 executes a program 110 of processor-executable instructions stored in memory 111. These instructions implement, among other programs of software, an operating system 112, a WLAN protocol processing stack 113, and a Bluetooth protocol processing stack 114. A WLAN driver 115 is illustrated here as part of WLAN stack 113 and provides an interface to the hardware of WLAN device 102. Similarly, a Bluetooth driver 116 is illustrated here as part of Bluetooth stack 114 and provides an interface to the hardware of Bluetooth device 101. The processor 109 is part of a digital baseband integrated circuit 117 that is coupled to the Bluetooth and WLAN devices 101 and 102 via a bus 118. Antenna 119 and RF transceiver integrated circuit 120 are used for cellular telephone communications and are controlled by the digital baseband integrated circuit 117 in conventional fashion.

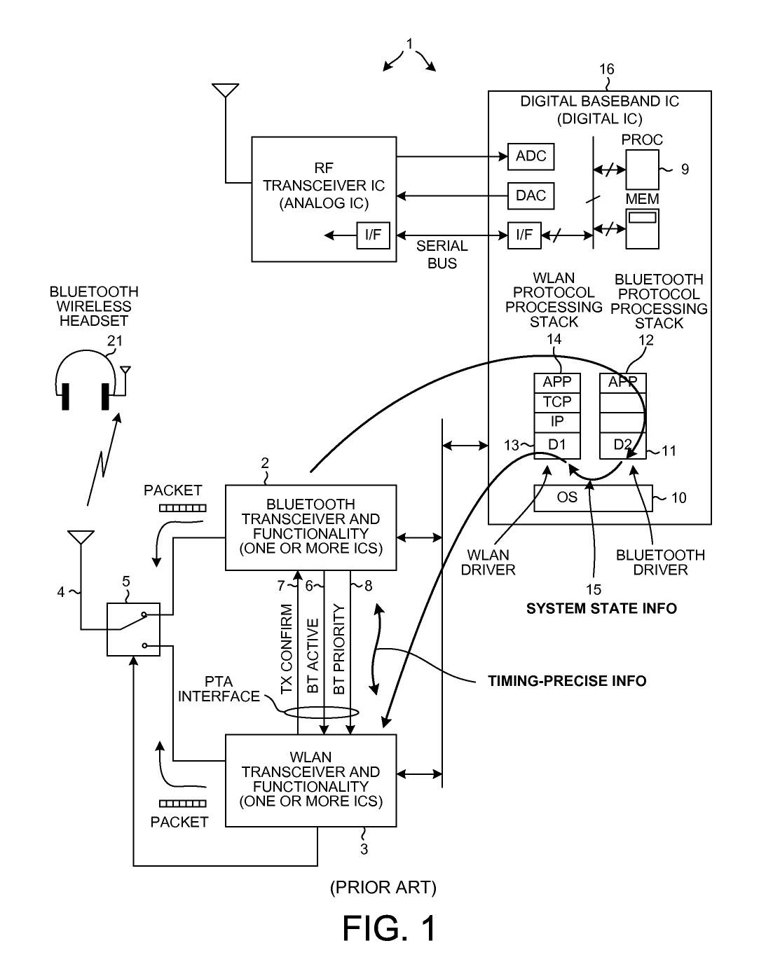

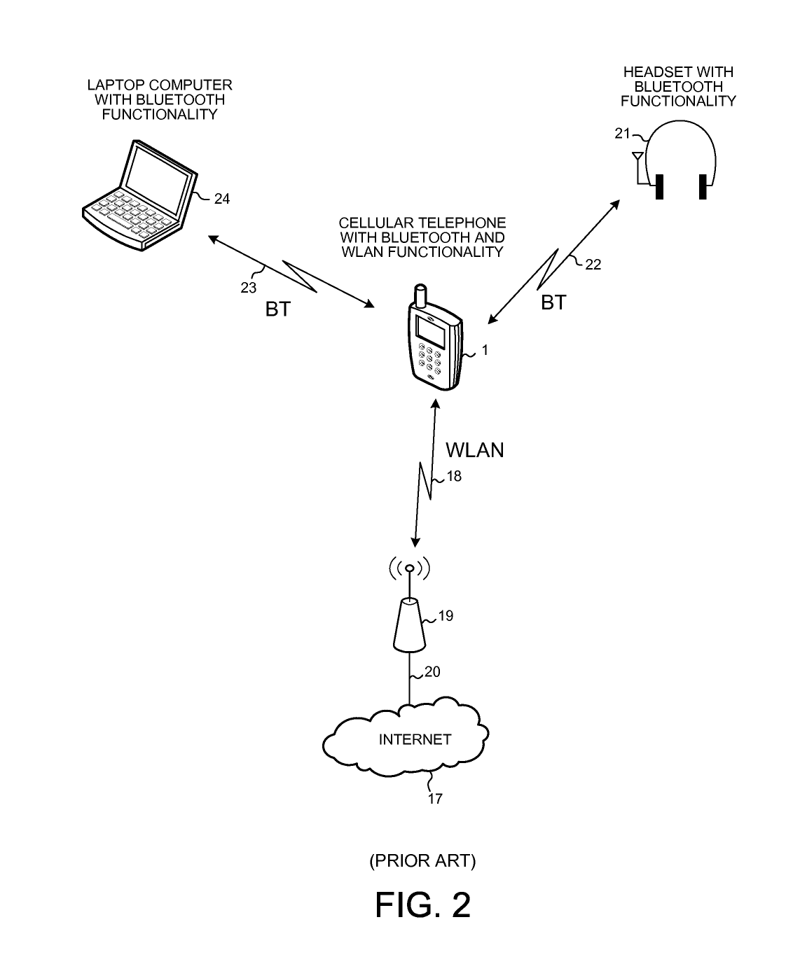

The conventional PTA interface of the prior art of FIG. 1 is replaced with a serial coexistence interface 130 involving conductor 121 and conductor 122. WLAN device 102 includes a UART 123 that sends serial information over conductor WLAN_DATA 121 in the form of serial messages 124 to Bluetooth device 102. Bluetooth device 101 includes a similar UART 125 for receiving the messages from the BT_DATA conductor 121. In addition, Bluetooth device 101 sends serial information over a conductor BT_DATA 122 in the form of serial messages 129 and 126 to WLAN device 102. The UART 123 of the WLAN device receives the messages from the BT_DATA conductor 122.

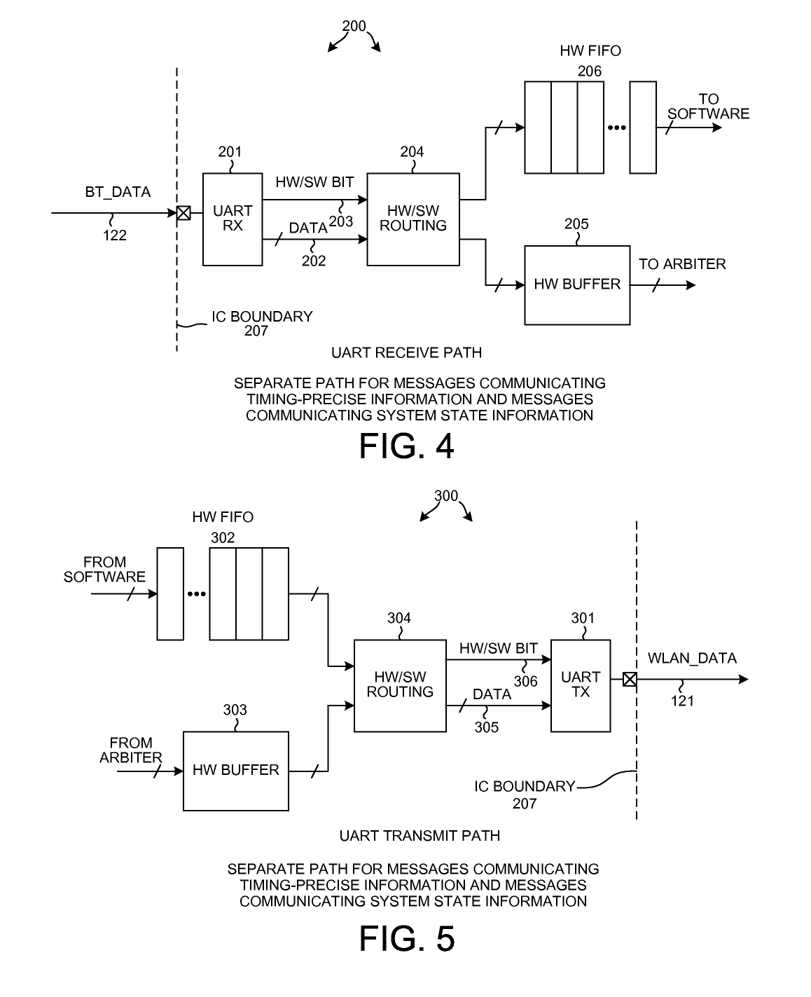

FIG. 4 is a more detailed diagram of the receive portion 200 of the arbitration functionality 104 of WLAN device 102. Block 201 represents the receiver (serial-to-parallel converter) portion of UART 123. Serial messages received on conductor 122 are converted into parallel form by block 201. The resulting parallel bits of the message on conductors 202 and 203 are passed to routing circuit 204. If a hardware/software bit of the message as received on conductor 203 indicates the message is a hardware message, then routing circuit 204 loads the bits of the message into a hardware buffer 205 storage mechanism. The contents of the hardware buffer 205 are accessible to the wireless transceiver coexistence arbiter (WTCA) 127. If the software/hardware bit of the message as received on conductor 203 indicates the message is a software message, then routing circuit 204 loads the bits of the message into a First-In-First-Out (FIFO) 206 storage mechanism that is accessible to software. The software in this case is software or firmware executed by a processor (not shown) of WLAN device 102. Reference numeral 207 indicates the boundary of the WLAN device 102. The message path to hardware buffer 205 is provided so that timing-critical hardware messages can be supplied to the arbiter as fast as possible without being delayed behind lower priority software messages.

FIG. 5 is a more detailed diagram of the transmit portion 300 of the arbitration functionality 104 of WLAN device 102. Block 301 represents the transmitter (parallel-to-serial converter) portion of UART 123. Messages for transmission can be deposited by software or firmware into FIFO 302 storage mechanism. Messages for transmission can also be loaded by the wireless transceiver coexistence arbiter (WTCA) 127 into hardware buffer 303 storage mechanism. Routing circuit 304 supplies the messages from FIFO 302 and buffer 303 one at a time in parallel form via conductors 305 and 306 to block 301. The value of the hardware/software bit in the ultimate message transmitted is determined by routing circuit 304 depending whether the message was taken from FIFO 302 or from buffer 303. The message path from hardware buffer 303 is provided so that timing-critical hardware messages can be received from the arbiter and transmitted as fast as possible without being delayed behind lower priority software messages.

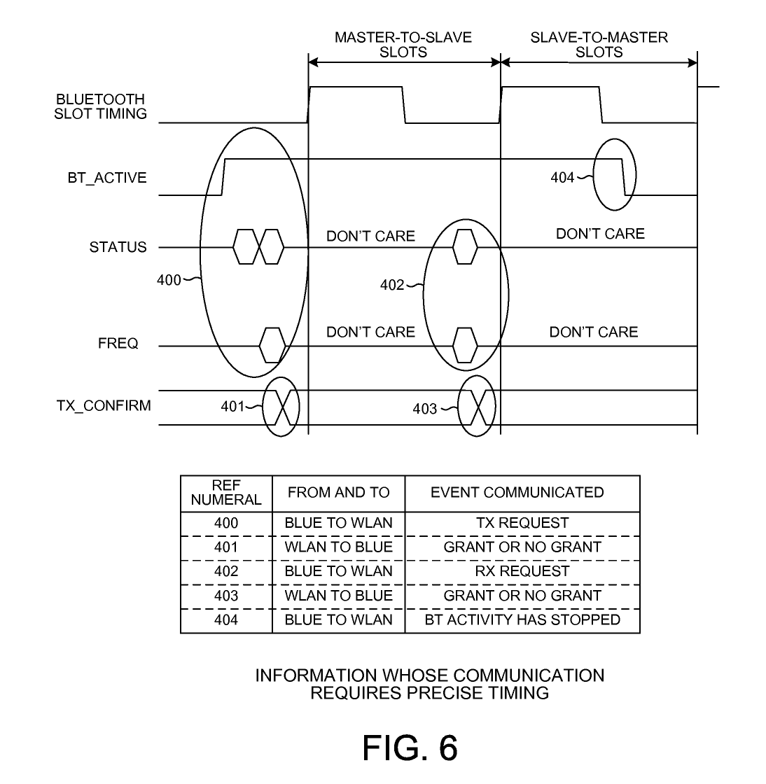

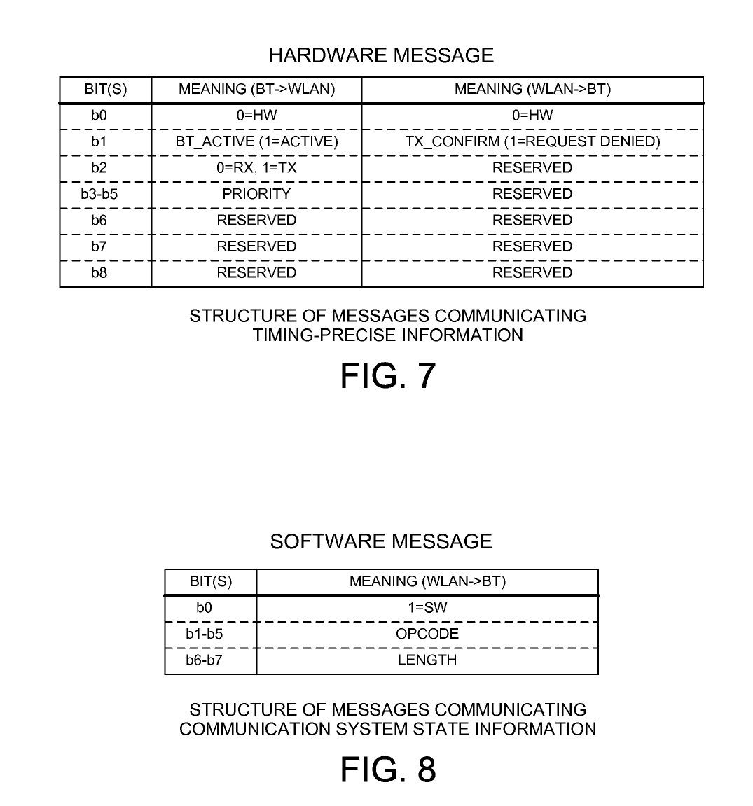

FIG. 6 is a diagram that illustrates signaling information that is communicated across a conventional PTA interface. In the embodiment of FIG. 3, this same information is communicated across the novel serial coexistence interface of FIG. 3 as timing-critical hardware messages. The waveforms illustrated in FIG. 6 are conventional PTA interface waveforms. The circle identified with reference numeral 400 indicates communication of a transmit request from a Bluetooth device to an arbiter in a WLAN device. The signal line BT_ACTIVE has a digital logic high value indicating that the Bluetooth device is active. The activity on the status line communicates one bit of priority information and also communicates whether the request is for transmitting or is for receiving. This same information, except that the priority information includes another bit of information, is communicated as a hardware message over the serial coexistence interface of FIG. 3 as explained below in connection with FIG. 7. In FIG. 6, the circle identified with reference numeral 401 indicates a conventional communication of a grant or no grant back to the Bluetooth device. If the signal on TX_CONFIRM is high then the response is a grant, whereas if the signal on TX_CONFIRM is low then the response is a no grant. This same information is communicated as a hardware message over the serial coexistence interface of FIG. 3 as explained below in connection with FIG. 7. The circle identified with reference numeral 402 indicates a conventional communication of a receive request from a Bluetooth device to an arbiter in a WLAN device. The signal on line BT_ACTIVE is high, indicating that the Bluetooth device is active. The activity on the status line communicates indicates that the request is for receiving. This same information is communicated as a hardware message over the serial coexistence interface of FIG. 3 as explained below in connection with FIG. 7. The circle identified with reference numeral 403 indicates a grant or no grant given in response to the receive request. Lastly, the circle identified with reference numeral 404 indicates a conventional communication indicating that Bluetooth activity has stopped. This same information is communicated as a hardware message over the serial coexistence interface of FIG. 3 as explained below in connection with FIG. 7.

FIG. 7 is a table that shows the eight bits of a timing-critical hardware message sent across the serial interface of FIG. 3. All such hardware messages are one eight-bit character long. The time when the eight-bit character is received indicates to the receiving device the timing of the event or information being communicated. If, for example, the transmit request identified by reference numeral 400 in FIG. 6 is to be communicated using a hardware message, then the first bit (bit b0) of the character would be a digital low to indicate a timing-precise hardware message. The second bit (bit b1) would be high to indicate the Bluetooth device is active. The third bit (bit b2) would be a digital high to indicate that the request is for a transmit, and not for receive. The fourth, fifth and sixth bits (bit b3, b4 and b5) would be set to indicate an appropriate level of priority. The values of bits b6, b7 and b8 would be don't cares. The time when this eight-bit message is received by the arbiter in the WLAN device indicates the time the transmit request is being made. The decoding of the bits in the hardware message is performed in the receiver in hardware so incoming hardware messages can be processed automatically in hardware without any software intervention.

FIG. 8 is a table that shows the eight bits of the first character of a software message sent across serial coexistence interface 130 of FIG. 3. Such a software message may be made to carry communication system state information. The first bit (bit b0) is a digital high to indicate a software message. The second through sixth bits (bit b1-b5) carry a five-bit opcode that determines the meaning of the message. The sixth and seventh bits indicate the number of follow-on characters that are also part of the message. Accordingly, software messages can be from one character to five characters in length.

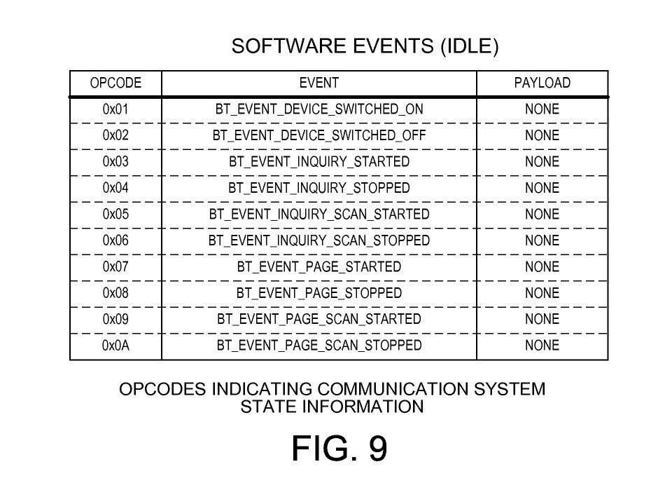

FIG. 9 is a table that sets forth opcodes for software events (idle) and their meanings in the specific example of FIG. 3. The opcodes of FIG. 9 are for single-character messages.

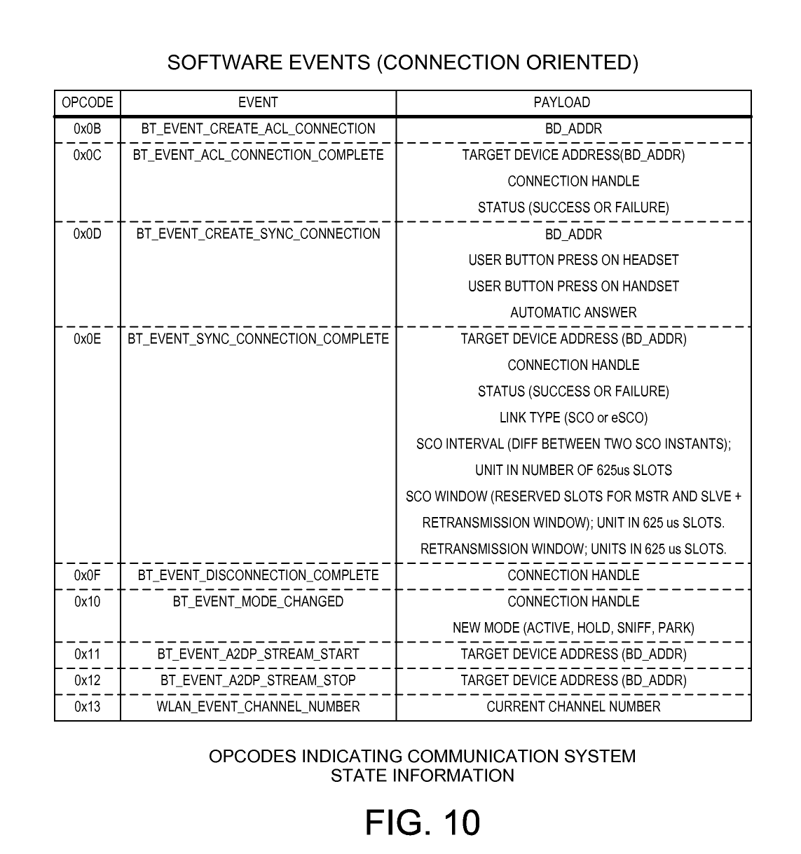

FIG. 10 is a table that sets forth opcodes for connection oriented software events and their meanings in the specific example of FIG. 3. In addition to the first character of the message that carries the five-bit opcode and the two-bit length value, the messages also include eight-bit follow-on payload characters. These payload characters carry parameters and other information. If, for example, the user of a Bluetooth headset were to press a button on the headset to pick up a telephone call, then this system state information would be communicated as a software message BT_EVENT_CREATE_SYNC_CONNECTION with an opcode of 0x0D from Bluetooth device 101 to WLAN device 102. This message indicates that a voice connection is being set up between the Bluetooth headset and the cellular telephone handset. This event could have been caused by the user pressing the button on the headset as in this example, by the user pressing a button on the cellular telephone handset, or if the user has automatic answer set up by the cellular telephone handset itself. In one example, the cause of the event is encoded in a payload character of the message. The processor in the WLAN device 102 receives this communication system state information and from it determines whether and how to change its arbitration strategy.

In a first novel aspect, a serial coexistence interface between two radio devices that want to share the same antenna is usable to communicate: 1) timing-precise antenna arbitration and control information, and 2) communication system state information. In one specific example, a single-character message is used to communicate the timing-precise antenna arbitration and control information, and the meanings of the eight bits of the message are set forth in FIG. 7. In one specific example, another message is used to communicate communication system state information. This message can be a single-character message or the message can involve multiple characters. The meanings of the various bits of the message are set forth in FIG. 8-10.

Some examples of timing-precise antenna arbitration and control information include: a transmit request communicated from the Bluetooth device to the WLAN device, a grant or no grant sent back from the WLAN device to the requesting Bluetooth device, a receive request communicated from the Bluetooth device to the WLAN device, a grant or no grant sent back from the WLAN device to the requesting Bluetooth device, and a “Bluetooth activity stopped” message communicated from the Bluetooth device to the WLAN device. These are events that must be communicated quickly because they are involved in the process of conducting packet-by-packet arbitration of granting access to the antenna. If the circuitry of FIG. 4 and FIG. 5 is employed, then communication of messages indicating these events is initiated by hardware one device and the messages are received by hardware in the other device.

The communication system state information, on the other hand, is not timing-precise event information involved in carrying out an antenna access arbitration but rather is high level state information of the overall communication system. The arbiter can use this information to determine what arbitration strategy to use. In one example, the communication system state information does not include radio environment characteristic data and does not include transceiver control commands. Some examples of communication system state information include: an indication of a button press, an indication of a user action, an indication of a starting or stopping of a synchronous Bluetooth connection, an indication of a starting or stopping of an asynchronous Bluetooth connection, an indication of a starting or stopping of an audio stream, an indication of a starting or stopping of a telephone call, an indication of a starting or stopping of streaming video playback, an indication of a starting or stopping of a paging operation, an indication of a starting or stopping of a scanning operation. A message containing the “create ACL connection” state information may, for example, be sent in response to a user initiating a file transfer over a Bluetooth connection. When exactly the Bluetooth device does the scan to initiate the connection for the file transfer is generally not critical down to the microsecond level like PTA interface signaling is. By communicating this “create ACL connection” state information across the serial coexistence interface between the Bluetooth and WLAN devices as opposed to passing the information between drivers in the host as in the prior art, problems and complexities in the prior art associated with driver-to-driver host communications are avoided. Communication system state information is not passed between the drivers using software messages as it was in the prior art of FIG. 1 as indicated by the crossed out arrow 128 in FIG. 3, but rather the communication system state information is communicated across the serial coexistence interface as indicated by arrow 129.

In a second novel aspect, a single serial message is sent across the serial coexistence interface and this single serial message includes all of the following: 1) information indicating which one of more than two levels of priority applies to a communication being requested by the device sending the message, 2) information indicating whether the device sending the message is requesting access to the antenna for transmitting (TX) or for receiving (RX), and 3) information indicating whether the device sending the message is active or not. In one example, individual request messages sent from a Bluetooth device to an arbiter in a WLAN device have three priority bits to indicate one of eight different priority levels. Where the Bluetooth device is requesting access to the antenna and is servicing two high priority Bluetooth links, and where one link is of higher priority than the other, the arbiter can use the multi-bit priority indicated in an incoming request to reduce access given to the link of lower priority without inadvertently reducing access to the highest priority link.

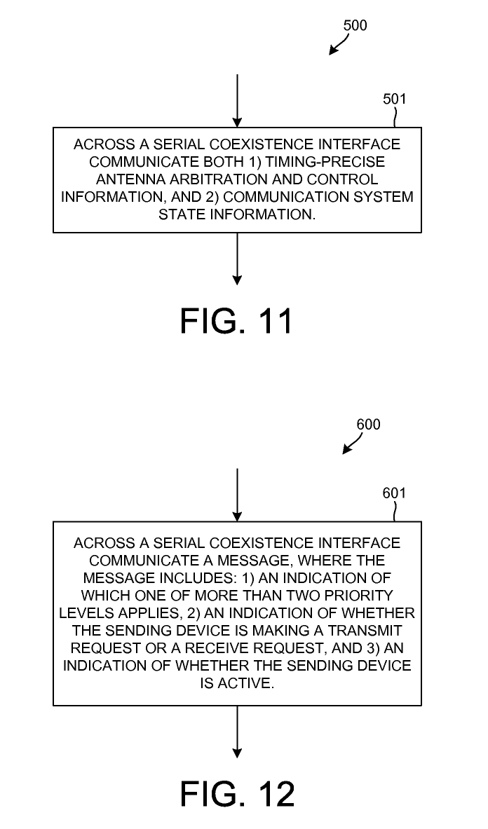

FIG. 11 is a flowchart of a method 500 in accordance with the first novel aspect. In step 501, both timing-precise antenna arbitration and control information as well as communication system state information are communicated across a serial coexistence interface. One specific example of this method is depicted in FIG. 3. Arrow 126 represents the timing-precise information. Arrow 129 represents the communication system state information. From the perspective of WLAN device 102, where device 102 is an integrated circuit, messages containing the timing-precise information 126 and the communication system state information 129 are received onto the integrated circuit from conductor 122 via serial bus terminal 131. Terminal 131 is a conductor and therefore is also a serial bus conductor. Similarly, WLAN device 102 outputs a grant or no grant message back to Bluetooth device 101 onto conductor 121 via serial bus terminal 132. Terminal 132 is a conductor and therefore is also a serial bus conductor.

FIG. 12 is a flowchart of a method 600 in accordance with the second novel aspect. In a step 601, a single message communicated across a serial coexistence interface includes all of the following: 1) information indicating which one of more than two levels of priority applies to a communication being requested by a device sending the message, 2) information indicating whether the device sending the message is requesting access to an antenna for transmitting (TX) or for receiving (RX), and 3) information indicating whether the device sending the message is active or not. One specific example of this method is depicted in FIG. 3. Arrow 126 represents the timing-precise information. The information is communicated in the form of a multi-bit serial message. The meanings of the bits of the message are set forth in FIG. 7.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. In one specific example, arbitration functionality 104 of WLAN device 102 is implemented as involving a processor that executes a set of process-executable instructions stored in a processor-accessible memory. The functionality of WTCA 127 of FIG. 3 and the UART circuitry of FIG. 4 and FIG. 5 is implemented as software that controls a small amount of specialized hardware circuitry. In a like manner, the UART functionality in Bluetooth device 101 is implemented as software that controls a small amount of specialized hardware circuitry. Circuit functionality can also be described in a hardware description language, and the description synthesized using a hardware synthesis software tool so that the function is realized in the form of dedicated hardware that performs the function. Depending on the application, arbitration functionality 104 and/or UART 125 can be largely implemented in dedicated specialized hardware, partially in such hardware and partially in software, or largely in software.

Although certain specific embodiments are described above for instructional purposes, the teachings of this patent document have general applicability and are not limited to the specific embodiments described above. The serial coexistence interface and protocol is not limited to use between Bluetooth and WLAN devices, but rather applies generally to coexistence situations in other architectures between other types of radios. The serial coexistence interface can be implemented to support communications between integrated circuits, or can be implemented to support communications between parts of the same integrated circuit. Although an example is set forth above where both timing-precise antenna arbitration and control information and communication system state information are communicated on the same conductor 122 from Bluetooth device 120 to WLAN device 101, both types of information may be made to pass in the opposite direction across conductor 121 from WLAN device 102 to Bluetooth device 101. Accordingly, various modifications, adaptations, and combinations of the various features of the described specific embodiments can be practiced without departing from the scope of the claims that are set forth below.

What is claimed is:

1. An apparatus comprising:
a first serial bus conductor over which first serial information is communicated onto the apparatus; and
a second serial bus conductor over which second serial information is communicated out of the apparatus, wherein one of the first and second serial information includes a wireless coexistence transmit request and communication system state information, and wherein the other of the first and second serial information includes a grant of the transmit request.

2. The apparatus of claim 1, wherein the communication system state information is taken from the group consisting of: an indication of a button press, an indication of a user action, an indication of a starting or stopping of a synchronous Bluetooth connection, an indication of a starting or stopping of an asynchronous Bluetooth connection, an indication of a starting or stopping of an audio stream, an indication of a starting or stopping of a telephone call, an indication of a starting or stopping of streaming video playback, an indication of a starting or stopping of a paging operation, and an indication of a starting or stopping of a scanning operation.

3. The apparatus of claim 1, wherein the wireless coexistence transmit request is encoded as a first multi-bit serial value.

4. The apparatus of claim 1, wherein the wireless coexistence transmit request is encoded as a multi-bit serial value, and wherein a first bit of the multi-bit serial value indicates a request, and wherein a second bit of the multi-bit serial value indicates that the request is for a transmit.

5. The apparatus of claim 1, wherein the wireless coexistence transmit request is encoded as a multi-bit serial value, and wherein at least two bits of the multi-bit serial value indicate a priority level.

6. The apparatus of claim 3, wherein the grant is encoded as a second multi-bit serial value.

7. The apparatus of claim 6, wherein the communication system state information is encoded as a third multi-bit serial value.

8. The apparatus of claim 1, wherein the communication system state information does not include a radio environment characteristic, and wherein the communication state information does not include a command to control a transceiver.

9. The apparatus of claim 1, further comprising:
a Wireless Transceiver Coexistence Arbiter (WTCA), wherein the apparatus is a Wireless Local Area Network (WLAN) transceiver device, wherein the wireless coexistence transmit request is received onto the apparatus, and wherein the grant is transmitted from the apparatus.

10. The apparatus of claim 1, wherein the apparatus is a Bluetooth transceiver device.

11. The apparatus of claim 1, further comprising:
a Universal Asynchronous Receiver/Transmitter (UART) operatively coupled to the first serial bus conductor, wherein the UART receives serial information and outputs parallel information;
a first storage mechanism;
a second storage mechanism; and
a routing circuit that examines the parallel information and based at least in part on the parallel information causes the parallel information to be written into a selected one of the first storage mechanism and the second storage mechanism.

12. The apparatus of claim 1, further comprising:
a Universal Asynchronous Receiver/Transmitter (UART) operatively coupled to the first serial bus conductor and to the second serial bus conductor.

13. The apparatus of claim 1, wherein the apparatus is an integrated circuit, and wherein the first and serial bus conductors are terminals of the integrated circuit.

14. The apparatus of claim 1, further comprising:
an arbitration functionality that receives the wireless coexistence transmit request and the communication system state information from the first serial bus conductor and that outputs the grant onto the second serial bus conductor, wherein the apparatus is an integrated circuit, and wherein the first and serial bus conductors are terminals of the integrated circuit.

15. A method comprising:
receiving a wireless coexistence transmit request via a first serial bus conductor and onto an apparatus;
receiving communication system state information via the first serial bus conductor and onto the apparatus; and
outputting a grant of the transmit request onto a second serial bus conductor and out of the apparatus.

16. The method of claim 15, wherein the apparatus is an integrated circuit, and wherein the first and second serial bus conductors are terminals of the integrated circuit.

17. The method of claim 15, wherein the wireless coexistence transmit request is encoded as a multi-bit serial value, wherein a first bit of the multi-bit serial value indicates a request, and wherein a second bit of the multi-bit serial value indicates that the request is for a transmit.

18. The method of claim 15, wherein the wireless coexistence transmit request is encoded as a multi-bit serial value, and wherein at least two bits of the multi-bit serial value indicate a priority level.

19. The method of claim 17, wherein the grant is encoded as multi-bit serial value.

20. The method of claim 17, wherein the communication system state information is encoded as a multi-bit serial value.

21. The method of claim 15, wherein the communication system state information is taken from the group consisting of: an indication of a button press, an indication of a user action, an indication of a starting or stopping of a synchronous Bluetooth connection, an indication of a starting or stopping of an asynchronous Bluetooth connection, an indication of a starting or stopping of an audio stream, an indication of a starting or stopping of a telephone call, an indication of a starting or stopping of streaming video playback, an indication of a starting or stopping of a paging operation and an indication of a starting or stopping of a scanning operation.

22. An apparatus comprising:
a first conductor;
a second conductor; and
means for receiving both a wireless coexistence transmit request and communication system state information from the first conductor, and for transmitting a grant of the transmit request onto the second conductor, wherein the wireless coexistence transmit request is communicated on the first conductor as a first serial multi-bit value, wherein the communication system state information is communicated on the first conductor as a second serial multi-bit value, and wherein the grant is communicated on the second conductor as a third serial multi-bit value.

23. The apparatus of claim 22, wherein the means includes a Universal Asynchronous Receiver/Transmitter (UART) and a Wireless Transceiver Coexistence Arbiter (WTCA).

24. An apparatus comprising:
a first conductor;
a second conductor; and
means for transmitting both a wireless coexistence transmit request and communication system state information onto the first conductor, and for receiving a grant of the transmit request from the second conductor, wherein the wireless coexistence transmit request is communicated on the first conductor as a first serial multi-bit value, wherein the communication system state information is communicated on the first conductor as a second serial multi-bit value, and wherein the grant is communicated on the second conductor as a third serial multi-bit value.

25. The apparatus of claim 24, wherein the apparatus is an integrated circuit, wherein the first and second conductors are terminals of the integrated circuit, and wherein the means includes a hardware Universal Asynchronous Receiver/Transmitter (UART) operatively coupled to the first and second conductors.

26. An apparatus comprising:
a serial bus conductor; and
a Universal Asynchronous Receiver/Transmitter (UART) operatively coupled to the serial bus conductor, wherein a single serial message is communicated across the serial bus conductor, and wherein the single serial message is a wireless transceiver coexistence message and includes: 1) information indicating which one of more than two levels of priority applies to a communication being requested by a device sending the message, 2) information indicating whether the device sending the message is requesting access to an antenna for transmitting (TX) or for receiving (RX), and 3) information indicating whether the device sending the message is active.

27. The apparatus of claim 26, wherein the apparatus is a Wireless Local Area Network (WLAN) transceiver integrated circuit, wherein the serial bus conductor is a terminal of the integrated circuit, and wherein the wireless transceiver coexistence message is received onto the apparatus.

28. The apparatus of claim 27, wherein the apparatus is a Bluetooth transceiver integrated circuit, wherein the serial bus conductor is a terminal of the integrated circuit, and wherein the wireless transceiver coexistence message is transmitted from the apparatus.

29. A method comprising:
communicating a single serial message across a serial conductor, wherein the single serial message is a wireless transceiver coexistence message and includes: 1) information indicating which one of more than two levels of priority applies to a communication being requested by a device sending the message, 2) information indicating whether the device sending the message is requesting access to an antenna for transmitting (TX) or for receiving (RX), and 3) information indicating whether the device sending the message is active.

30. The method of claim 29, wherein the communicating is a receiving of the single serial message onto a Wireless Local Area Network (WLAN) transceiver device via the serial conductor.

31. The method of claim 29, wherein the communicating is a transmitting of the single serial message from a Bluetooth transceiver device via the serial conductor.
